(19) United States
(12) Patent Application Publication
(10) Pub. No.: US 2016/0014664 A1
(43) Pub. Date: Jan. 14, 2016

(54) HAND-OVER CONTROL BETWEEN WIRELESS FIDELITY (WIFI) SYSTEMS AND LONG TERM EVOLUTION (LTE) SYSTEMS

(71) Applicant: Sprint Communications Company L.P., Overland Park, KS (US)

(72) Inventors: Jasinder Pal Singh, Olathe, KS (US); Siddharth Oroskar, Overland Park, KS (US); Maulik K. Shah, Austin, TX (US)

(21) Appl. No.: 14/327,825

(22) Filed: Jul. 10, 2014

(51) Int. Cl. H04W 36/30; H04W 36/14

(52) U.S. Cl. CPC H04W 36/30; H04W 36/14

(57) ABSTRACT

A Long Term Evolution (LTE) User Equipment (UE) stores a WiFi over LTE communication priority as a current communication priority, and in response, wirelessly exchanges user data through a WiFi access point. The LTE UE also wirelessly receives and processes LTE service enhancement data from an LTE access point. In response to processing the LTE service enhancement data, the LTE UE stores an LTE over WiFi communication priority as the current communication priority. In response to the LTE over WiFi communication priority, the LTE UE wirelessly exchanges additional user data through the LTE access point using an LTE service enhancement.

### TECHNICAL BACKGROUND

Wireless communication services are available using various types of wireless User Equipment (UE). Many of these wireless UEs communicate over both Wireless Fidelity (WiFi) networks and Long Term Evolution (LTE) networks. In many cases, a UE will first try to use WiFi instead of LTE based on a default communication priority of WiFi over LTE. If the default communication priority is WiFi over LTE, then the UE scans for a WiFi signal of sufficient quality before scanning for an LTE signal of sufficient quality. If a WiFi signal of sufficient quality is found, then the UE communicates over the WiFi system. The UE will then scan for LTE signals if the WiFi signal fades away, or to look for LTE pages on a periodic schedule.

As the UE moves away from the WiFi access node, its WiFi service may degrade from an optimal level to a sub-optimal level nearer the edge of the WiFi coverage area. Note that even though the WiFi signal is no longer optimal, it remains adequate, so the UE remains on sub-optimal but adequate WiFi. If the sub-optimal WiFi degrades further to an inadequate state, then the UE will attempt a hand-over to LTE.

Enhanced communication services are available from some LTE systems. These enhanced services include carrier aggregation, beamforming, and Multiple Input Multiple Output (MIMO) services. These enhanced services can often extend the range or throughput of an LTE system. Unfortunately, the UE does not have an efficient and effective way to hand-over to enhanced LTE services when on a sub-optimal but adequate WiFi system.

### TECHNICAL OVERVIEW

A Long Term Evolution (LTE) User Equipment (UE) stores a WiFi over LTE communication priority as a current communication priority, and in response, wirelessly exchanges user data through a WiFi access point. The LTE UE also wirelessly receives and processes LTE service enhancement data from an LTE access point. In response to processing the LTE service enhancement data, the LTE UE stores an LTE over WiFi communication priority as the current communication priority. In response to the LTE over WiFi communication priority, the LTE UE wirelessly exchanges additional user data through the LTE access point using an LTE service enhancement.

### DESCRIPTION OF THE DRAWINGS

FIGS. 1-2 illustrate a communication system having a UE to control hand-overs between a WiFi access point and an LTE access point based on LTE service enhancement data.

FIGS. 3-5 illustrate a communication system having a UE to control hand-overs between a WiFi node and an LTE eNodeB based on LTE SIB data.

FIG. 6 illustrates a UE to control hand-overs between a WiFi node and an LTE eNodeB.

FIG. 7 illustrates a SIB data structure to control hand-overs between a WiFi node and an LTE eNodeB.

### DETAILED DESCRIPTION

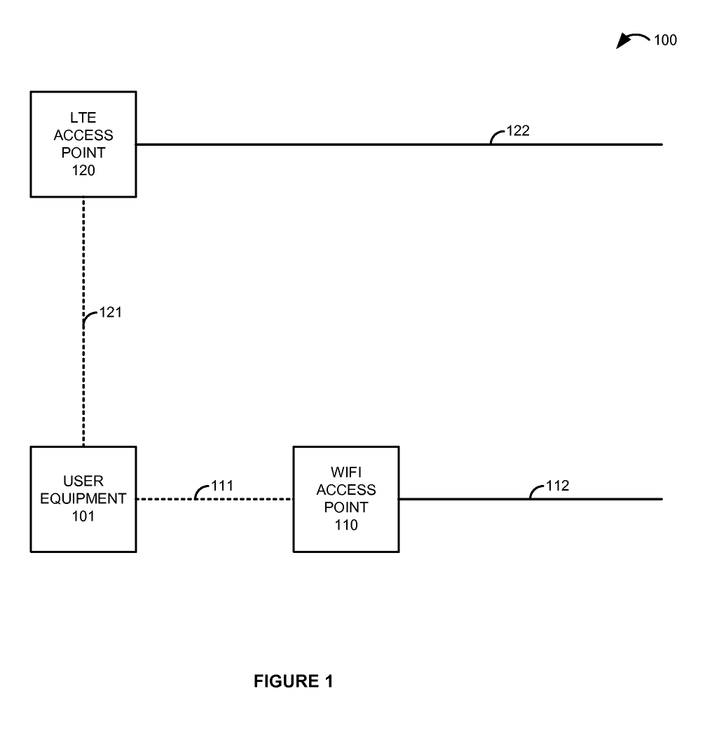

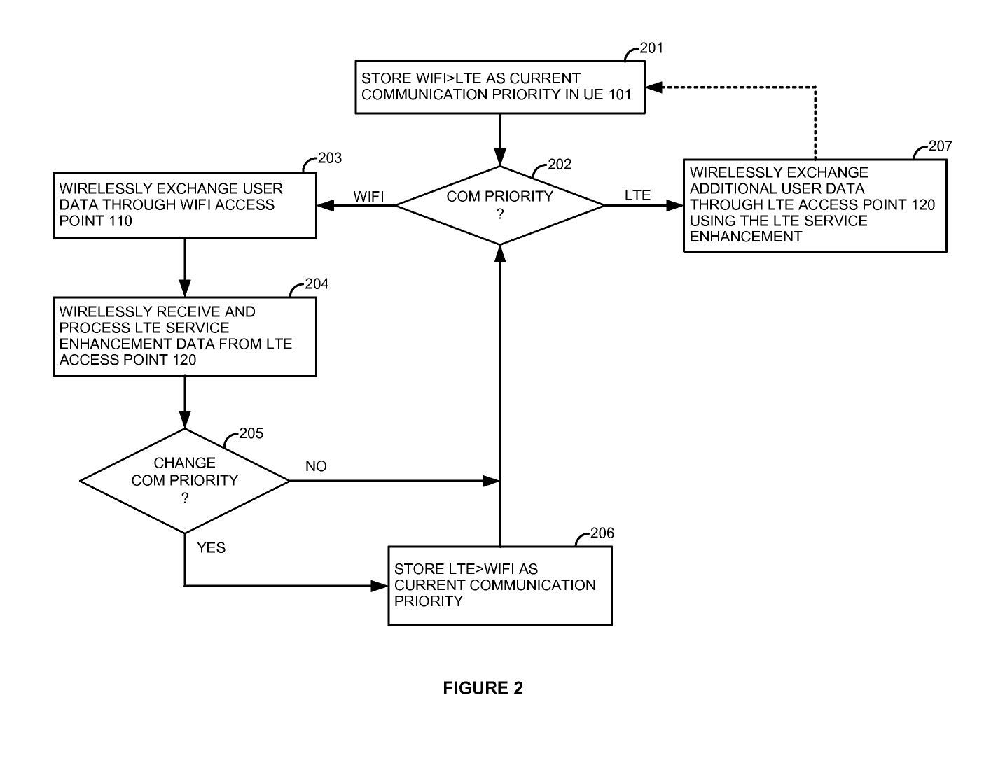

FIGS. 1-2 illustrate communication system 100 having User Equipment (UE) 101 to control hand-overs between Wireless Fidelity (WiFi) access point 110 and Long Term Evolution (LTE) access point 120 based on LTE service enhancement data. Communication system 100 comprises UE 101, WiFi access point 110, and LTE access point 120. UE 101 could be a phone, computer, media player, internet appliance, and/or some other apparatus having wireless transceiver components. WiFi access point 110 could be a WiFi hotspot, modem, base station, and the like. LTE access point 120 could be an eNodeB, relay, base station, and the like.

UE 101 and WiFi access point 110 wirelessly communicate over WiFi link 111. WiFi access point 110 and other systems communicate over network link 112. UE 101 and LTE access point 120 wirelessly communicate over LTE link 121. LTE access point 120 and other systems communicate over network link 122.

UE 101 stores a communication priority that it uses to scan for LTE and WiFi signals. If the current communication priority is WiFi over LTE, then UE 101 scans for a WiFi signal of sufficient quality before scanning for an LTE signal of sufficient quality. If a WiFi signal of sufficient quality is found, then UE 101 communicates over the WiFi system. UE 101 will then scan for LTE signals if the WiFi signal fades. UE 101 may also scan for LTE signals on a periodic basis to read pages and notices and to report network signals or other data to LTE systems.

If the current communication priority is LTE over WiFi, then UE 101 scans for an LTE signal of sufficient quality before scanning for a WiFi signal of sufficient quality. If an LTE signal of sufficient quality is found, then UE 101 communicates over the LTE system. UE 101 will then scan for WiFi signals if the LTE signal fades. UE 101 may also scan for WiFi signals on a periodic basis to read pages and notices and to report network signals or other data.

In operation, UE 101 stores a WiFi over LTE communication priority as its current communication priority. This WiFi over LTE communication priority may be set during device manufacture, activation, or during actual usage. In response to the WiFi over LTE communication priority, UE 101 wirelessly exchanges user data through WiFi access point 110 and links 111-112. In response to the WiFi over LTE communication priority, UE 101 also wirelessly receives and processes LTE service enhancement data from LTE access point 120 over LTE link 121. In some examples, UE 101 reads the LTE service enhancement data from an LTE System Information Block (SIB) that is broadcast from LTE access point 120.

In response to processing the LTE service enhancement data, UE 101 now stores an LTE over WiFi communication priority as the current communication priority. In response to the LTE over WiFi communication priority, UE 101 wirelessly exchanges additional user data through LTE access point 120 and links 121-122 using an LTE service enhancement. Thus, UE 101 may use the enhanced LTE service over LTE link 121 even though an adequate WiFi signal is still available over WiFi link 111.

In some examples, UE 101 wirelessly reads service data from an LTE System Information Block (SIB) responsive to WiFi signal strength being below an LTE scan threshold. This LTE scan threshold may correspond to an adequate but not optimal WiFi signal, such as the adequate WiFi signal within but near the edge of the WiFi coverage area. UE 101 would use a strong WiFi signal without reading the service data from the LTE SIB, but if the WiFi signal becomes merely adequate, then UE 101 can look for enhanced LTE services in the broadcast SIB. Thus, UE 101 may direct a hand-over to LTE even though WiFi service is still adequate.

The service data in the LTE SIB may provide information on available carrier aggregation services, beamforming services, Multiple Input Multiple Output (MIMO) services, and/or some other wireless services—including combinations thereof. UE 101 may then direct a hand-over to LTE if the WiFi signal is merely adequate and if the appropriate enhanced LTE service is available. For example, UE 101 might direct the hand-over to LTE if beamforming services are available even though WiFi service is adequate.

The service data in the LTE SIB may provide Quality-of-Service (QoS) information for the available carrier aggregation services, beamforming services, Multiple Input Multiple Output (MIMO) services, or some other wireless services. For example, the LTE SIB may indicate types of carrier aggregation (intra-spectrum contiguous-frequency, intra-spectrum non-contiguous frequency, inter-spectrum non-contiguous frequency), beamforming (fixed, adaptive, space-division), and/or MIMO (8×2, 8×4, 16×2, 16×4). The LTE SIB may indicate expected data rates for associated LTE signal strengths when using various enhanced services or service combinations. UE 101 may direct a hand-over to LTE if the WiFi signal is merely adequate and if the QoS of an appropriate enhanced service is acceptable. For example, UE 101 might direct the hand-over to LTE if 16×4 MIMO services are available even though WiFi service is still adequate.

In some examples, UE 101 wirelessly queries LTE access point 120 for enhanced service data for the UE responsive to WiFi signal strength being below an LTE query threshold. The query entails activation of the reverse portion of LTE link 121. The LTE scan threshold may correspond to an adequate but not optimal WiFi signal. UE 101 could then use strong/optimal WiFi without querying for the enhanced service data, but if the WiFi signal becomes merely adequate, then UE 101 would then query for enhanced LTE service data. The service data in the query response may indicate available carrier aggregation services, beamforming services, MIMO services, and/or some other wireless services—including combinations thereof. The service data in the query response may provide QoS information for the available carrier aggregation services, beamforming services, MIMO services, and/or other wireless services. For example, the response may indicate types of carrier aggregation, beamforming, and/or MIMO. The response may indicate expected data rates for associated LTE signal strengths when using various enhanced services or service combinations.

UE 101 comprises computer and communication circuitry, user interfaces, data storage devices, and associated software/hardware components. Access points 110 and 120 comprise computer and communication circuitry, data processing and storage equipment, and associated software/hardware components. Wireless links 111 and 112 propagate electromagnetic signals over air or space using respective WiFi and LTE protocols. Network links 111 and 112 propagate electromagnetic signals over air, space, metal, glass, plastic, or some other conductive element using various communication protocols, such as internet, Ethernet, packet radio, and the like. Communication links 111-112 and 121-122 may include intermediate devices, systems, and networks.

Referring to FIG. 2, UE 101 initially stores WiFi over LTE as its current communication priority (201). The WiFi over LTE communication priority may be set during device manufacture, activation, or during actual usage. Subsequently, UE 101 determines its current communication priority for wireless scans and communications (202). If the current communication priority is WiFi over LTE (202), then UE 101 wirelessly exchanges user data through WiFi access point 110 (203)—assuming the WiFi signal is adequate. UE 101 also wirelessly receives and processes LTE service enhancement data from LTE access point 120 (204).

For example, UE 101 may determine when WiFi signal strength/throughput crosses a threshold from optimal to adequate. This optimal/adequate threshold could be WiFi signal strength/throughput at a range between 60%-80% toward the edge of the WiFi coverage area where LTE scanning and hand-over would be attempted. If this optimal/adequate WiFi threshold is crossed, then UE 101 would read carrier aggregation, beamforming, and MIMO QoS data from the LTE SIB from LTE access point 120.

UE 101 processes the LTE service enhancement data to determine if the communication priority of WiFi over LTE should be changed to LTE over WiFi (205). For example, UE 101 may compare the SIB QoS data for the current LTE signal strength to determine that LTE will outperform WiFi. In response to a determination that LTE over WiFi should be the communication priority (205), UE 101 stores LTE over WiFi as the current communication priority (206). In response to the LTE over WiFi communication priority (202), UE 101 now wirelessly exchanges additional user data through LTE access point 120 using an LTE service enhancement, such as carrier aggregation, beamforming, MIMO, or some other feature (207). As indicated by the dash line on FIG. 2, UE 101 eventually returns its current communication priority to WiFi over LTE (201) and the process may repeat.

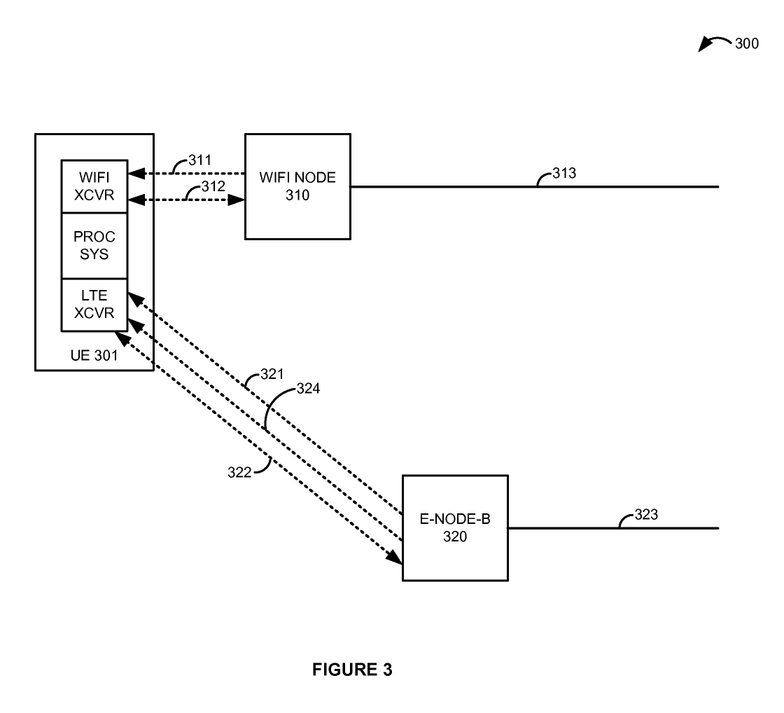

FIGS. 3-5 illustrate communication system 300 having UE 301 to control hand-overs between WiFi node 310 and LTE eNodeB 320 based on LTE SIB data. Communication system 300 comprises UE 301, WiFi node 310, and LTE eNodeB 320. UE 301 comprises a WiFi transceiver, LTE transceiver, and processing system. The WiFi transceiver receives WiFi beacon signal 311 from WiFi node 310 and exchanges wireless data 312 with WiFi node 310. The LTE transceiver receives LTE pilot signal 321 from eNodeB 320 and exchanges wireless data 322 with eNodeB 320. WiFi node 312 and eNodeB 320 communicate with other systems communicate over respective network links 313 and 323.

The LTE transceiver in UE 301 also receives LTE SIB signal 324 from eNodeB 320. LTE SIB signal 324 indicates various enhanced LTE services, such as beamforming, MIMO, and carrier aggregation. LTE SIB signal 324 may also indicate QoS levels for the enhanced services as related to received signal strength at the UE.

The processing system in UE 301 maintains a communication priority in memory that it uses to prioritize the scanning and subsequent use of LTE and WiFi signals. When the current communication priority is WiFi over LTE, then UE 301 scans for WiFi beacon signal 311 before scanning for LTE pilot signal 321. If WiFi beacon signal 311 has sufficient quality, then UE 301 exchanges wireless data 312 through WiFi node 310 and link 313. UE 301 may scan for LTE pilot signal 321 on a periodic basis to read pages. When the current communication priority is LTE over WiFi, then UE 301 scans for LTE pilot signal 321 before scanning for WiFi beacon signal 311. If LTE pilot signal 321 has sufficient quality, then UE 301 exchanges wireless data 322 through eNodeB 320 and link 323.

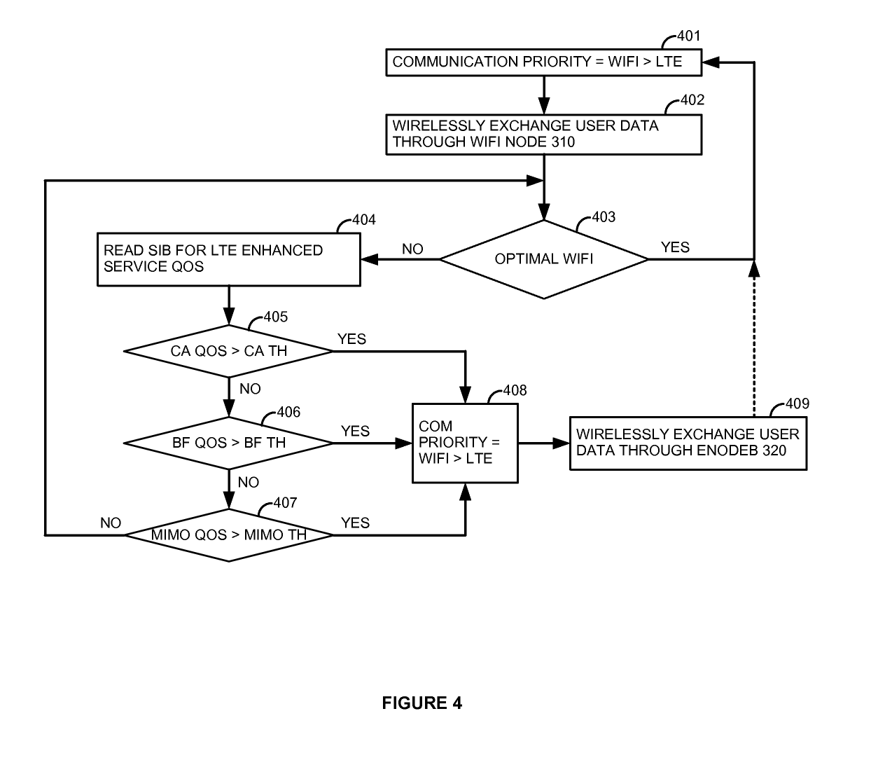

Referring to FIG. 4, UE 301 sets its communication priority to WiFi over LTE (401). In response to the WiFi over LTE communication priority, UE 301 wirelessly exchanges user data 311 through WiFi node 310 (402). If the WiFi signal remains above an optimal quality threshold (403), then UE 301 maintains its communication priority to WiFi over LTE (401). This optimal/adequate quality threshold could be the WiFi signal strength and/or WiFi data throughput at a point that is 66% of the way from the center to the edge of the WiFi coverage area—where LTE scanning and hand-over would normally be attempted.

If the WiFi signal falls below the optimal quality threshold (403), then UE 301 reads SIB signal 324 to determine available enhanced services and their associated QoS metrics (404). If carrier aggregation QoS is above a CA threshold (405), then UE 301 changes the communication priority to LTE over WiFi (408). If beamforming QoS is above a beamforming threshold (406), then UE 301 changes the communication priority to LTE over WiFi (408). If MIMO QoS is above a MIMO threshold (407), then UE 301 changes the communication priority to LTE over WiFi (408).

In response to a LTE over WiFi communication priority (408), UE 301 wirelessly exchanges user data 322 through eNodeB 320 using the appropriate LTE service enhancement. Thus, UE 301 may use the enhanced LTE service over LTE through eNodeB 320 even though an adequate WiFi signal is still available from WiFi node 310. As indicated by the dash line on FIG. 4, UE 301 eventually returns its current communication priority to WiFi over LTE (401) and the process may repeat.

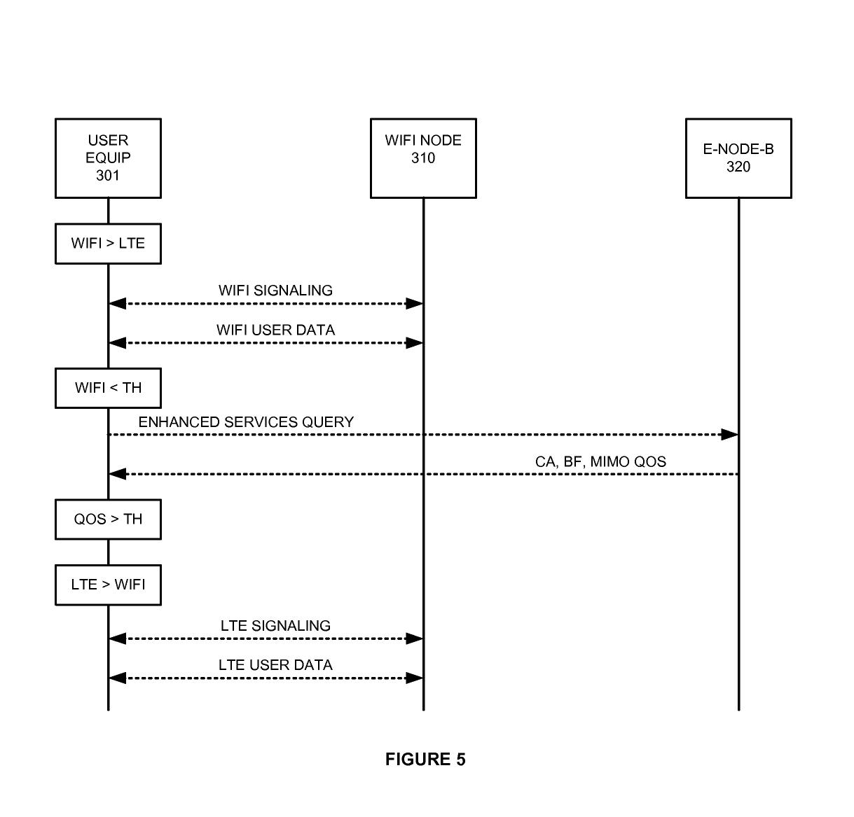

Now referring to FIG. 5, UE 301 sets its communication priority to WiFi over LTE. In response to the WiFi over LTE communication priority, UE 301 wirelessly exchanges WiFi signaling and user data with WiFi node 310. If the WiFi signal remains above an optimal quality threshold, then UE 301 maintains its communication priority to WiFi over LTE. When the WiFi signal falls below the optimal quality threshold, then UE 301 attaches to eNodeB 320 and transfers a query to eNodeB 320 determine available enhanced services and their associated QoS metrics. eNodeB 320 responds to UE 301 with carrier aggregation QoS, beamforming QoS, MIMO QoS, and the like. If one or more of the QoS metrics are above a QoS threshold, then UE 301 changes the communication priority to LTE over WiFi. In response to the LTE over WiFi communication priority, UE 301 wirelessly exchanges LTE signaling and user data with eNodeB 320.

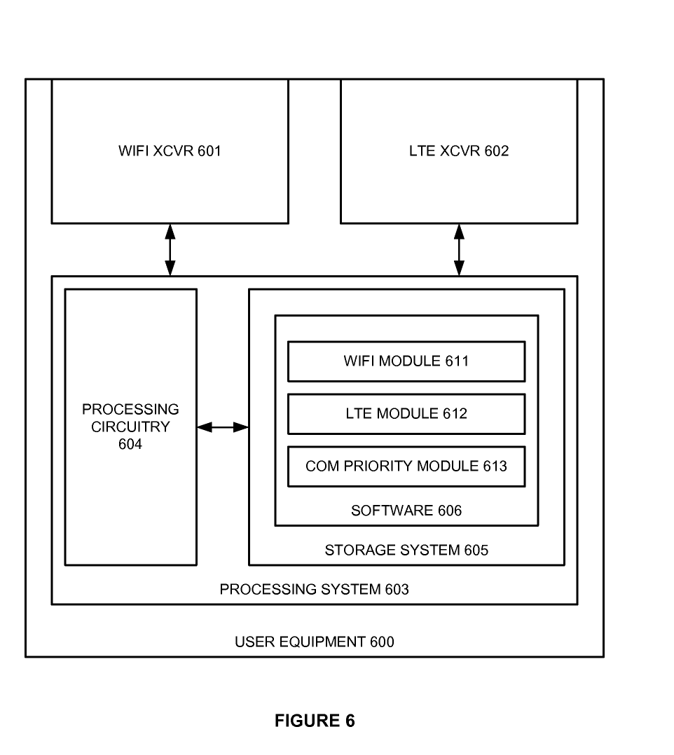

FIG. 6 illustrates User Equipment (UE) 600 to control hand-overs between a WiFi node and an LTE eNodeB. UE 600 is an example of UEs 101 and 301, although this equipment may use alternative configurations and operations. UE 600 comprises WiFi transceiver 601, LTE transceiver 602, and processing system 603. Processing system 603 comprises processing circuitry 604 and storage system 605. Storage system 605 stores software 606. Software 606 includes software modules 611-613. Some conventional aspects of UE 600 are omitted for clarity, such as power supplies, enclosures, and the like. UE 600 may be centralized or distributed and may include various virtualized components.

Transceivers 601-602 comprise wireless communication components, such as antennas, amplifiers, filters, modulators, and the like. WiFi transceiver 601 uses the WiFi protocol and LTE transceiver 602 supports the LTE protocol. In processing system 603, processing circuitry 604 comprises circuit boards, integrated circuitry, and associated electronics. Storage system 605 comprises non-transitory, machine-readable, data storage media, such as flash drives, disc drives, memory circuitry, servers, and the like. Software 606 comprises machine-readable instructions that control the operation of processing circuitry 604 when executed. Software 606 includes software modules 611-613 and may also include operating systems, applications, data structures, utilities, databases, and the like. All or portions of software 606 may be externally stored on one or more storage media, such as flash drives, discs, servers, and the like.

When executed by processing circuitry 604, WiFi module 611 directs circuitry 604 to attach and communicate over suitable WiFi systems based on the communication priority. When executed by processing circuitry 604, LTE module 612 directs circuitry 604 to attach and communicate over suitable LTE systems based on the communication priority. When executed by processing circuitry 604, communication priority module 613 directs circuitry 604 to process WiFi signal quality and LTE enhanced service data to control the communication priority as described herein, and in particular, to change a default WiFi over LTE communication priority to an LTE over WiFi communication priority if WiFi becomes sub-optimal and LTE enhanced services are available at the appropriate QoS.

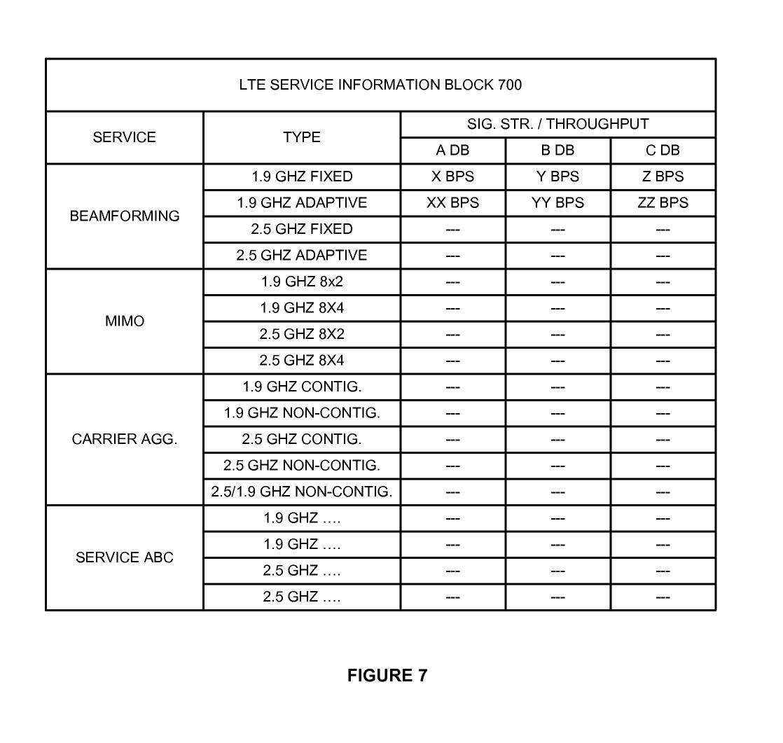

FIG. 7 illustrates LTE SIB 700 to control hand-overs between a WiFi node and an LTE eNodeB. The first column lists various enhanced services including beamforming, MIMO, and carrier aggregation. The second column lists types of the enhanced services on a per-frequency basis. For example, MIMO services include 8×2 MIMO at 2.5 GHz. The third, fourth, and fifth columns indicate the expected data throughput in Bits Per Second (BPS) for various received signal strengths in decibels (DB). The LTE signal strength could be measured by RSRP (Reference Signal Receive Power), RSSI (Received Signal Strength Indicator), RSRQ (Reference Signal Receive Quality), or some other metric.

UEs in suboptimal WiFi coverage may read SIB 700 to determine the expected enhanced LTE throughput for the current received LTE signal strength. The UEs may then compare the actual sub-optimal WiFi throughput to the expected enhanced LTE throughput to control communication priorities. In particular, the UEs can change their default WiFi over LTE communication priority to an LTE over WiFi communication priority if WiFi becomes sub-optimal and LTE enhanced services are available at the appropriate QoS.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a Long Term Evolution (LTE) User Equipment (UE) comprising:
storing a WiFi over LTE communication priority as a current communication priority, and in response, wirelessly exchanging user data through a WiFi access point;
in response to exchanging the user data through the WiFi access point, wirelessly receiving and processing LTE service enhancement data from an LTE access point;
in response to processing the LTE service enhancement data, storing an LTE over WiFi communication priority as the current communication priority; and
in response to the LTE over WiFi communication priority as the current communication priority, wirelessly exchanging additional user data through the LTE access point using an LTE service enhancement.

2. The method of claim 1 wherein:
wirelessly receiving the LTE service enhancement data in response to exchanging the user data through the WiFi access point comprises wirelessly reading an available carrier aggregation service for the UE from an LTE System Information Block responsive to WiFi signal strength being below an LTE scan threshold;
storing the LTE over WiFi communication priority as the current communication priority in response to processing the LTE service enhancement data comprises storing the LTE over WiFi communication priority as the current communication priority in response to the available carrier aggregation service for the UE; and
wirelessly exchanging the additional user data through the LTE access point using the LTE service enhancement comprising wirelessly exchanging the additional user data using the available carrier aggregation service.

3. The method of claim 1 wherein:
wirelessly receiving the LTE service enhancement data in response to exchanging the user data through the WiFi access point comprises wirelessly reading an available beamforming service for the UE from an LTE System Information Block responsive to WiFi signal strength being below an LTE scan threshold;
storing the LTE over WiFi communication priority as the current communication priority in response to processing the LTE service enhancement data comprises storing the LTE over WiFi communication priority as the current communication priority in response to the available beamforming service for the UE; and
wirelessly exchanging the additional user data through the LTE access point using the LTE service enhancement comprising wirelessly exchanging the additional user data using the available beamforming service.

4. The method of claim 1 wherein:
wirelessly receiving the LTE service enhancement data in response to exchanging the user data through the WiFi access point comprises wirelessly reading an available Multiple Input Multiple Output (MIMO) service for the UE from an LTE System Information Block responsive to WiFi signal strength being below an LTE scan threshold;
storing the LTE over WiFi communication priority as the current communication priority in response to processing the LTE service enhancement data comprises storing the LTE over WiFi communication priority as the current communication priority in response to the available MIMO service for the UE; and
wirelessly exchanging the additional user data through the LTE access point using the LTE service enhancement comprising wirelessly exchanging the additional user data using the available MIMO service.

5. The method of claim 1 wherein:
wirelessly receiving the LTE service enhancement data in response to exchanging the user data through the WiFi access point comprises wirelessly reading carrier aggregation Quality of Service (QoS) from an LTE System Information Block responsive to WiFi signal strength being below an LTE scan threshold;
storing the LTE over WiFi communication priority as the current communication priority in response to processing the LTE service enhancement data comprises storing the LTE over WiFi communication priority as the current communication priority in response to the carrier aggregation QoS above a WiFi-to-LTE handover threshold; and
wirelessly exchanging the additional user data through the LTE access point using the LTE service enhancement comprising wirelessly exchanging the additional user data using a carrier aggregation service.

6. The method of claim 1 wherein:
wirelessly receiving the LTE service enhancement data in response to exchanging the user data through the WiFi access point comprises wirelessly reading beamforming Quality of Service (QoS) from an LTE System Information Block responsive to WiFi signal strength being below an LTE scan threshold;
storing the LTE over WiFi communication priority as the current communication priority in response to processing the LTE service enhancement data comprises storing the LTE over WiFi communication priority as the current communication priority in response to the beamforming QoS above a WiFi-to-LTE handover threshold; and
wirelessly exchanging the additional user data through the LTE access point using the LTE service enhancement comprising wirelessly exchanging the additional user data using a beamforming service.

7. The method of claim 1 wherein:
wirelessly receiving the LTE service enhancement data in response to exchanging the user data through the WiFi access point comprises wirelessly reading Multiple Input Multiple Output (MIMO) Quality of Service (QoS) from an LTE System Information Block responsive to WiFi signal strength being below an LTE scan threshold;
storing the LTE over WiFi communication priority as the current communication priority in response to processing the LTE service enhancement data comprises storing the LTE over WiFi communication priority as the current communication priority in response to the MIMO QoS above a WiFi-to-LTE handover threshold; and
wirelessly exchanging the additional user data through the LTE access point using the LTE service enhancement comprising wirelessly exchanging the additional user data using a MIMO service.

8. The method of claim 1 wherein:
wirelessly receiving the LTE service enhancement data in response to exchanging the user data through the WiFi access point comprises wirelessly querying an LTE access point for carrier aggregation service data for the UE responsive to WiFi signal strength being below an LTE query threshold;
storing the LTE over WiFi communication priority as the current communication priority in response to processing the LTE service enhancement data comprises storing the LTE over WiFi communication priority as the current communication priority in response to the carrier aggregation service data for the UE; and
wirelessly exchanging the additional user data through the LTE access point using the LTE service enhancement comprising wirelessly exchanging the additional user data using the available carrier aggregation service.

9. The method of claim 1 wherein:
wirelessly receiving the LTE service enhancement data in response to exchanging the user data through the WiFi access point comprises wirelessly querying an LTE access point for beamforming service data for the UE responsive to WiFi signal strength being below an LTE query threshold;
storing the LTE over WiFi communication priority as the current communication priority in response to processing the LTE service enhancement data comprises storing the LTE over WiFi communication priority as the current communication priority in response to the beamforming service data for the UE; and
wirelessly exchanging the additional user data through the LTE access point using the LTE service enhancement comprising wirelessly exchanging the additional user data using the available beamforming service.

10. The method of claim 1 wherein:
wirelessly receiving the LTE service enhancement data in response to exchanging the user data through the WiFi access point comprises wirelessly querying an LTE access point for Multiple Input Multiple Output (MIMO) service data for the UE responsive retrieving service data for the UE from an LTE access point responsive to WiFi signal strength being below an LTE query threshold;
storing the LTE over WiFi communication priority as the current communication priority in response to processing the LTE service enhancement data comprises storing the LTE over WiFi communication priority as the current communication priority in response to the retrieved MIMO service data for the UE; and
wirelessly exchanging the additional user data through the LTE access point using the LTE service enhancement comprising wirelessly exchanging the additional user data using the available MIMO service.

11. A Long Term Evolution (LTE) User Equipment (UE) comprising:
a communication transceiver system configured to wirelessly communicate with an LTE access point and with a Wireless Fidelity (WiFi) access point;
a processing system configured to store a WiFi over LTE communication priority as a current communication priority, and in response, to direct the communication transceiver system to wirelessly exchange user data through the WiFi access point and to wirelessly receive LTE service enhancement data from the LTE access point; and
the processing system configured to process the LTE service enhancement data to store an LTE over WiFi communication priority as the current communication priority, and in response to the LTE over WiFi communication priority as the current communication priority, to direct the communication transceiver system to wirelessly exchange additional user data through the LTE access point using an LTE service enhancement.

12. The LTE UE claim 11 wherein the processing system configured to:
direct the wireless transceiver system to read an available carrier aggregation service for the UE from an LTE System Information Block responsive to WiFi signal strength being below an LTE scan threshold,
store the LTE over WiFi communication priority as the current communication priority in response to the available carrier aggregation service for the UE; and
direct the wireless transceiver system to exchange the additional user data through the LTE access point using the available carrier aggregation service.

13. The LTE UE claim 11 wherein the processing system configured to:
direct the wireless transceiver system to read an available beamforming service for the UE from an LTE System Information Block responsive to WiFi signal strength being below an LTE scan threshold,
store the LTE over WiFi communication priority as the current communication priority in response to the available beamforming service for the UE; and
direct the wireless transceiver system to exchange the additional user data through the LTE access point using the available beamforming service.

14. The LTE UE claim 11 wherein the processing system configured to:
direct the wireless transceiver system to read an available Multiple Input Multiple Output (MIMO) service for the UE from an LTE System Information Block responsive to WiFi signal strength being below an LTE scan threshold,
store the LTE over WiFi communication priority as the current communication priority in response to the available MIMO service for the UE; and
direct the wireless transceiver system to exchange the additional user data through the LTE access point using the available MIMO service.

15. The LTE UE claim 11 wherein the processing system configured to:
direct the wireless transceiver system to read carrier aggregation Quality of Service (QoS) from an LTE System Information Block responsive to WiFi signal strength being below an LTE scan threshold;
store the LTE over WiFi communication priority as the current communication priority in response to the carrier aggregation QoS above a WiFi-to-LTE handover threshold; and
direct the wireless transceiver system to exchange the additional user data through the LTE access point using a carrier aggregation service.

16. The LTE UE claim 11 wherein the processing system configured to:
direct the wireless transceiver system to read beamforming Quality of Service (QoS) from an LTE System Information Block responsive to WiFi signal strength being below an LTE scan threshold;
store the LTE over WiFi communication priority as the current communication priority in response to the beamforming QoS above a WiFi-to-LTE handover threshold; and
direct the wireless transceiver system to exchange the additional user data through the LTE access point using a beamforming service.

17. The LTE UE claim 11 wherein the processing system configured to:
direct the wireless transceiver system to read Multiple Input Multiple Output (MIMO) Quality of Service (QoS) from an LTE System Information Block responsive to WiFi signal strength being below an LTE scan threshold;
store the LTE over WiFi communication priority as the current communication priority in response to the MIMO QoS above a WiFi-to-LTE handover threshold; and
direct the wireless transceiver system to exchange the additional user data through the LTE access point using a MIMO service.

18. The LTE UE claim 11 wherein the processing system configured to:
direct the wireless transceiver system to wirelessly query an LTE access point for carrier aggregation service data for the UE responsive to WiFi signal strength being below an LTE query threshold;
store the LTE over WiFi communication priority as the current communication priority in response to the carrier aggregation service data for the UE; and
direct the wireless transceiver system to exchange the additional user data through the LTE access point using the available carrier aggregation service.

19. The LTE UE claim 11 wherein the processing system configured to:
direct the wireless transceiver system to wirelessly query an LTE access point for beamforming service data for the UE responsive to WiFi signal strength being below an LTE query threshold;
store the LTE over WiFi communication priority as the current communication priority in response to the beamforming service data for the UE; and
direct the wireless transceiver system to exchange the additional user data through the LTE access point using the available beamforming service.

20. The LTE UE claim 11 wherein the processing system configured to:
direct the wireless transceiver system to wirelessly query an LTE access point for Multiple Input Multiple Output (MIMO) service data for the UE responsive to WiFi signal strength being below an LTE query threshold;
store the LTE over WiFi communication priority as the current communication priority in response to the MIMO service data for the UE; and
direct the wireless transceiver system to exchange the additional user data through the LTE access point using the available MIMO service.
